(19) United States
(12) Patent Application Publication
(10) Pub. No.: US 2006/0175255 A1
(43) Pub. Date: Aug. 10, 2006

(54) Systems and methods for generation of low zeta potential mineral crystals and hydrated electrons to enhance the quality of liquid solutions

(75) Inventor: Walter J. Bauer, Baden (CA)

Correspondence Address: SPECKMAN LAW GROUP PLLC, 1201 THIRD AVENUE, SUITE 330, SEATTLE, WA, 98101, US

(73) Assignee: Bauer Energy Design, Inc., Baden (CA)

(21) Appl. No.: 11/350,290

(22) Filed: Feb. 7, 2006

Related U.S. Application Data
(60) Provisional application No. 60/651,040, filed on Feb. 7, 2005.

(51) Int. Cl. B01D 11/04

(52) U.S. Cl. 210/634

(57) ABSTRACT

Methods and systems for enhancing quality of liquids by treating a source liquid to enhance the concentration of low zeta potential crystals and hydrated electrons and produce a treated liquid having a higher concentration of low zeta potential crystals and hydrated electrons than that of the source liquid. The inventive system comprises an aqueous liquid source having a threshold concentration of selected minerals and a liquid treatment system for treating the aqueous source liquid to produce treated liquid having an enhanced concentration of low zeta potential crystals and hydrated electrons.

### CROSS REFERENCE TO RELATED APPLICATION

This application claims priority under 35 U.S.C. §119(e) to U.S. Provisional Application No. 60/651,040, filed Feb. 7, 2005.

### FIELD OF THE INVENTION

The present invention generally relates to systems and methods for generating low zeta potential mineral crystals and hydrated electrons to enhance the quality of liquid solutions.

### BACKGROUND OF THE INVENTION

A common hazard of liquids, especially water for drinking, household, medical, and industrial uses, is contamination by harmful microorganisms such as bacteria, viruses, cysts, and the like. Gastrointestinal disorders and illnesses are caused by water contaminated by microorganisms. The microorganisms present in liquid systems can come from a variety of sources. The safety and potability of certain water supplies, using source liquid from wells, springs, water pumps, septic tanks, reservoirs, water treatment devices, water lines, and the like, is a serious health and safety concern.

Bacteria and microorganisms present in water unfortunately cannot be seen, tasted, smelled, or easily detected, and many health-related symptoms are caused by bacteria and microorganisms that are not immediately visible. Water contamination is generally identified by one or a panel of laboratory tests. However, testing a water supply for a specific disease-causing organism can be quite expensive. Also, handling and intentionally culturing disease producing organisms requires special training and equipment.

Boiling of water is known to be an extremely effective means to eliminate bacterial populations and ensure that the water is safe. Water that has been boiled continuously for at least 15 minutes will be substantially free from nearly all bacteria. However, this method of eliminating bacteria and microorganisms in water is not always practical and almost impossible for treatment of large volumes of water. It is also common nowadays for a person to purchase bottled water for personal consumption or use an in-home water filtration system, but these alternatives to tap water again can be costly and can become cumbersome.

Most household water can be disinfected continuously by chlorination, distillation, ultraviolet light, or ozonation. Chlorination is widely used to disinfect water because it destroys bacteria within a reasonable contact time and provides long term protection. Chlorine, readily available at a low cost, is easy to handle and is also effective in controlling algae. However, chlorine has its limitations. Organic matter as well as iron and manganese can interfere with the action of chlorine. Low levels of chlorine normally used to disinfect water are not an effective treatment for some parasites and microorganisms, and even low levels of chlorine concentrations can result in objectionable tastes and odors. Chlorinators, although simple to operate, require regular refilling with chemicals. Chlorine bleach can be added to water for sanitation purposes and sanitizing a contaminated well, a spring, a swimming pool, or a plumbing system, for example, can be accomplished by shock chlorination. However, shock chlorination introduces high levels of chlorine in the water and high levels of chlorine can be toxic and can be irritable to human organs and skin and Therefore, while water treated by chlorine may be suitable for some applications and settings, it may not be suitable or safe for human consumption. In addition, water treatment equipment, such as water softeners, iron filters, or sand filters, can be damaged by strong chlorine solutions.

The heat necessary to provide water distillation is very effective in killing disease-causing microorganisms. One of the benefits of distillation is that the process uses no chemicals. Distillation, however, takes longer to produce the processed water than some other methods. Also, the distillation units can be expensive to operate, and the long period of storing distilled water can affect its quality.

Exposure to ultraviolet light is also a very effective methodology for disinfecting water. This method also disinfects water without adding chemicals. Ultraviolet light disinfection units do not create any new chemical complexes, do not change the taste or odor of the water, and do not remove beneficial minerals from the water. However, ultraviolet light is only effective against some bacteria. It is not effective against some viruses and parasites such as giardia. In addition, there is no simple test to determine whether disinfection by ultraviolet light provides a proper level of disinfection. Further, ultraviolet light devices are most effective when water is clear and such devices allow the light to easily pass through. Thus, to ensure proper disinfection, ultraviolet light device often need to be combined with other treatment devices such as mechanical filters, activated carbon filters, water softeners, and reverse osmosis systems to provide complete water quality solutions.

Ozonation uses ozone, which is a more powerful disinfectant than chlorine. Ozone produces no tastes or odors in the water. However, as a gas, ozone is unstable and has a very short life so it must be generated at the point of use. This is impractical and cumbersome.

Corrosion inside the piping system of water supplies can further reduce the quality of water. High levels of iron in water due to rust in the piping system of water supplies can cause various illness and disorders. Rust, a mixture of iron oxides and hydroxides, is formed when metal compounds corrode in the presence of water and oxygen. Corrosion is a process where chemical reactions take place through the exchange of electrons. The process of rusting can be summarized as three basic stages. First, iron (II) ions are formed from the metal. Second, hydroxide ions are formed. Third, iron oxide molecules (FeO(OH)) are formed from the reaction of iron (II) ions, hydroxide ions, and ambient oxygen, and rust is created.

Rust can be prevented by insulating the metal from moisture and oxygen by covering the metal with a protective coating such as spray-on type rust proofing, undercoating, or paint. However, it is sometimes impossible to cover every area of the “rust-proof” areas, and often these areas are most prone to corrosion. Also, the protective coating method is only effective when the protective surface is not damaged. When damage occurs, no matter how small, rust will occur. Further, the protective coating method involves the use of chemicals, which can be toxic and hazardous.

Another method to prevent rust is capacitive coupling, which relies on paint as a dielectric or barrier to the free electrons, causing the metal to be at a lower potential difference, theoretically slowing rust formation. The system's positive electrode acts as the positive side of the capacitor effect and the protected surface forms the negative side with the paint as the dielectric (insulator). Capacitive coupling relies on water to form a continuous electrolyte, between the positive electrode and any “scratches” that form, to allow electron flow to disrupt the rusting process. However, in normal conditions, when there is no water (electrolyte) present, there is no possibility of electron flow between the positive electrode and the “scratch”. Hence, there is no rust protection and the free electrons can readily react to form rust.

Cathodic protection is another method commonly used to prevent rust using either impressed current or sacrificial anode. Cathodic protection can effectively be used to control corrosion on existing metal surfaces. Cathodic protection prevents corrosion by making a metal behave like a cathode and be free from corrosive attack. This is achieved by providing electrons of a higher energy level (electric potential) than those which would be produced in the corrosion reaction at the natural anode. Thus, even if corrosion is occurring, cathodic protection can be applied to stop the corrosion damage from increasing. Cathodic protection can, however, only stop further corrosion from occurring and cannot restore the material already lost due to corrosion. Further, cathodic protection requires a source of electrical current (high energy electrons) to prevent the corrosive attack on metal and the equipment used in connection with the cathodic protection method can be quite costly.

Numerous water treatment methods and devices are known in the art. U.S. Pat. No. 5,591,317 discloses an electrostatic-field generator for use in water treatment that consists of a vitrified ceramic tube of unibody construction having a single open end adapted to receive a high-voltage power cable through an insulated cap. The interior surface of the ceramic tube is lined with a layer of conductive material electrically connected to the power cable, thereby providing a relatively-large conductive surface in intimate contact with the dielectric surface of the ceramic tube. In operation, the device is immersed in a body of water connected to ground and the power cable is energized with a high DC voltage, thereby creating an electrostatic field across the dielectric of the tube's ceramic and across the body of water. Because of the difference in the dielectric coefficients of the materials, the majority of the applied potential is measured across the water, thus providing the desired electrostatic effect on its particulate components.

U.S. Pat. No. 5,817,224 discloses a method for enhancing the efficiency of a solid-liquid separation process by using an electrostatic-field generator that utilizes a vitrified ceramic tube of unibody construction having a single open end adapted to receive a high-voltage power cable through an insulated cap. The interior surface of the ceramic tube is lined with a layer of conductive material electrically connected to the power cable, thereby providing a relatively-large conductive surface in intimate contact with the dielectric surface of the ceramic tube. The device is used in connection with conventional chemical additives for separating suspended solids from water to reduce chemical consumption and improve operating efficiency. The device is immersed in the water carrying suspended particles upstream of the treatment with chemical agents and is energized with a high DC voltage, thereby creating an electrostatic field across the dielectric of the tube's ceramic and across the body of water. The charge on the surface of particles to be separated by physical aggregation is altered by the electrostatic field so generated and is manipulated so as to produce enhanced performance by the chemicals used in the conventional process downstream.

U.S. Pat. No. 4,772,369 discloses a process and an apparatus for treating water which comprises decomposing the minerals dissolved in the water into cations comprising ferromagnetic, paramagnetic and residual particles, and disaggregating the cations and anions by utilizing ferromagnetic particles as a temporary mobile anode facing a strong cathode and paramagnetic particles as a weak cathode. The disaggregated minerals form a dielectric layer on the strong cathode, which is extracted.

U.S. Pat. No. 6,679,988 discloses a water purification system for production of USP purified water and/or USP water for injection including a backwashable, chlorine tolerant microfilter or ultrafilter for initial filtration of the feed water. The filtrate from the filter is provided to a dechlorinator prior to being subjected to an optional, reverse osmosis membrane unit and then to a still which discharges purified water at USP standards for purified water or water for injection.

U.S. Pat. No. 6,689,270 discloses a water treatment apparatus reducing hard water deposits in a conduit. Water having dissolved salts therein causing scaling is treated by flowing through a passage in an elongate tubular member. The tubular member has a first metal inside surface exposed to the water. A second metal surface is positioned therein and the two surfaces have areas of 1:1 up to about 125% with the second metal being different from the first metal. The metal surfaces are electrically insulated from each other so that current flow between the two is through the water.

U.S. Pat. No. 6,849,178 discloses an apparatus for water treatment by means of an electrical field is provided with an anode and a cathode in at least one treatment chamber through which the water to be treated passes. The apparatus is characterized in that the at least one treatment chamber forms a prismatic space with an elongated cross section, the anode and the cathode are formed by pairs of parallel, stick-shaped electrodes which extend spaced apart into said space and a voltage is applicable between the electrodes. One end of the at least one treatment chamber is connected to a water inlet and the other end of the at least one treatment chamber is connected to a water outlet, whereby a waterflow from one electrode to the other is generated, which is substantially transverse to the longitudinal axes of the electrodes.

### SUMMARY OF THE INVENTION

The present invention provides methods and systems for enhancing quality of liquid solutions by generating a generally high concentration of low zeta potential mineral crystals and hydrated electrons in the liquid solutions. The inventive system treats source liquid in a low zeta potential crystal generator, thereby changing the crystalline structure of minerals such as calcium carbonate (CaCO₃) in the solution, and enhancing the concentration of low zeta potential crystals in the treated liquid. The source liquid solution is preferably water, but other aqueous solutions may be used as source liquids. The system also treats source liquid or treated liquid in a hydrated electron generator capable of reducing the size of clusters of liquid molecules, resulting in smaller sized liquid molecules. The resonance frictional energy among the smaller liquid molecules generates hydrated electrons in the source/treated liquid, which inhibit the corrosion of metals. The treated liquid is then distributed for use and consumption.

The treatment sequence of the source liquid in the low zeta potential crystal generator and the hydrated electron generator is interchangeable. Source liquid may be treated first in a low zeta potential crystal generator, and the treated liquid, containing an enhanced concentration of low zeta potential mineral crystals, is next treated in the hydrated electron generator. Alternatively, source liquid may be treated first in a hydrated electron generator, and the treated liquid, containing an enhanced concentration of hydrated electrons, is next treated in the low zeta potential crystal generator.

The present invention also provides methods and systems for alternating and repeating treatments of liquid solutions. Source liquid may be treated first in a first low zeta potential crystal generator, and the treated liquid is next treated in the hydrated electron generator. The twice-treated liquid is subsequently treated in a second low zeta potential crystal generator. Alternatively, source liquid can be treated first in a first hydrated electron generator, and the treated liquid is next treated in the low zeta potential crystal generator. The twice-treated liquid is subsequently treated in a second hydrated electron generator.

Low zeta potential crystal generators suitable for use in the present invention may comprise a passive electro mechanical device that catalyses the crystallization of minerals in liquid solutions. Zeta potential is the electrical potential that exists across the interface of all solids and liquids. Almost all particulate or macroscopic materials in contact with a liquid acquire charges on their surfaces. Zeta potential is an important and useful indicator of these charges and can be used to predict and control the stability of colloidal suspensions or emulsions. The lower the zeta potential, the more likely the suspension is to be stable because the charged particles repel one another and thus overcome the natural tendency to aggregate.

Calcium carbonate (CaCO₃) is generally present in at least moderate concentrations in water. In methods and systems of the present invention, calcium carbonate ionic species in the source liquid solution are crystallized to produce aragonite.
Ca²⁺+CO₃²⁻→CaCO_{3(s)(aragonite)}
Aragonite is a common carbonate mineral and a polymorph of calcite. In other words, aragonite has the same chemistry as calcite but it has a different structure, and more importantly, different symmetry and crystal shapes. Aragonite's more compact structure is composed of triangular carbonate ion groups (CO₃), with a carbon at the center of the triangle and the three oxygens at each corner. Unlike calcite, the carbonate ions of an aragonite do not lie in a single plane pointing in the same direction. Instead, they lie in two planes that point in opposite directions, thereby destroying the trigonal symmetry that is characteristic of calcite's structure. Aragonite crystal formation and the conditions of the aragonite crystal growth are such that cations other than calcium are entrapped within the crystal lattice. This condition modifies the distribution of the charge at the surface of the crystals and lowers the zeta potential of the crystals. Minerals other than calcium carbonate may also be induced to form low zeta potential crystals.

One exemplary low zeta potential crystal generator suitable for use in methods and systems of the present invention is known as the “Turbu-Flow™” treatment system. The Turbu-Flow™ system is well known in the art and is described, for example, in Australia Patent No. 580474. The principle by which the Turbu-Flow™ system operates is a surface electro-chemical reaction between the crystalline particles which exist in a source liquid and the special alloy elements forming the core of the Turbu-Flow™ system.

The Turbu-Flow™ treatment system comprises a stack of metal alloy conditioning discs. The liquid flow path through the unit maximizes turbulent flow over the surfaces of the conditioning elements. The discs are constructed of metal alloys selected from two groupings of metals of opposite electro-negativity. When an ion-laden liquid solution contacts the elements, the ions are attracted onto the elements, causing them to become neutralized. The turbulence of liquid flow facilitates neutralization of the ionic species and removal of the ions as neutral particles in a harmless colloidal suspension.

The density of crystal seeds produced by a low zeta potential crystal generator such as the Turbu-Flow™ system is generally high, and the continued growth of the crystals formed in the treated liquid is prevented because of the rapid drop in the calcium (and other minerals) ion concentrations in the treated liquid. The crystals generated thus remain at a size in the range of nano size particles (generally from 1 to 999 nm). The Turbu-Flow™ system's effect on crystal structure and formation and the difference in low zeta potential crystal composition between untreated liquids and liquids treated with the Turbu-Flow™ system was not previously known.

In addition to observing that the zeta potential of crystals present in water treated by the Turbu-Flow™ system is substantially different from that of untreated water, it has been unexpectedly discovered the Turbu-Flow™ system is exceptionally effective in the enhancement of the quality and stability of the liquid solutions. Experimental results demonstrate that liquid solutions having a relatively high concentration of low zeta potential mineral crystals has the ability to reduce growth of various microorganisms in relatively low liquid temperatures.

Hydrated electron generators suitable for use in the present invention are capable of preventing corrosion by generating a chemical reaction in water. This reaction converts rust-causing iron oxide molecules (FeO(OH)) to magnetite (Fe₃O₄). Water generally comprises big masses of water molecules because of the abundance of hydrogen bonds, and minimal electrons are generated under these water conditions. The hydrated electron generator utilizes energy generated by nuclear magnetic resonance (NMR), or other molecule forces, to “spin” the nucleus of the hydrogen atoms of the water molecules and the large clusters of water molecules are consequently reduced to smaller-sized water molecules. The spinning of hydrogen nuclei prevents the water molecules from bonding to each other. As a result of the resonance energy, the water condition is elevated to the exited state and generates a high concentration of hydrated electrons discharged by the friction among the water molecules. A hydrated electron may be chemically expressed as an electron surrounded by oriented water molecules. These hydrated electrons cause the iron oxide molecules present in water to convert to magnetite, thus preventing corrosion of metals caused by water. This system and method of generating hydrated electrons is extremely effective to inhibit inside of iron-containing water supply conduits.

One exemplary hydrated electron generator suitable for use in methods and systems of the present invention is known as the “NMR Pipetector™”. The NMR Pipetector™ is well known in the art. NMR Pipetector™ was designed and has been used to reduce rust, prevent scale, and protect and prolong the life of the water pipes. The NMR Pipetector™ is also capable of improving the solubility of the water. Further, since water treated by the NMR Pipetector™ can infiltrate into cells easier than that of untreated water, water treated by a NMR Pipetector™ is very effective in breaking the cell membranes of microorganisms and eliminating microorganism growth.

Other known hydrated electron generators capable of generating a magnetic field and/or electric field among water particles, thereby generating hydrated electrons, may be incorporated with the systems and methods of the present invention. When a conductive fluid passes through a magnetic field, an electromotive force is induced through the fluid perpendicular to the direction of fluid flow and the flux field. This electrical discharge through the fluid induces a positive polarity in the fluid. The magnetic flux field further causes polar water molecules to be aligned along the flux or magnetomotive force vector, thus affecting the kinetics of crystallization of the minerals in the water. Random covalent bonding of the nucleation points of these scale forming molecular clusters is reduced and, therefore, these minerals stay in suspension. In the case of calcium carbonate, the crystal form becomes delicate aragonite rather than hard calcite. Both crystals have the same empirical formula, but their internal bonding and physical strengths are very different. Further, as the water flows past the magnets, the molecules are aligned to a uniform directional field. Water regains its solvency and will not allow the minerals to form crystals of scale.

Examples of the above described hydrated electron generators include, but are not limited to, AQUA-CORRECT® and AQUA Hydro Physical Systems®, Ecoflow® H2flow® magnetic water conditioner, GMX™ water softeners, Magnetic Magic™ water treatment system, Magna-Tek™ water treatment system, Mundimex™ Magnetizer, Magnetic Solutions™ water treatment system, SpaceAge® magnetic water treatment system, and Superior Water Conditioner®.

The methods and systems of the present invention utilize a source liquid solution, such as tap water, municipal water, well water, wastewater, and the like, containing minerals. In one embodiment, the source liquid may be treated prior to treatment in a low zeta potential crystal generator or a hydrated electron generator to remove contaminants such as debris, oils, and other substances that would interfere with the crystallization treatment. In another embodiment, the mineral composition of the source liquid may be determined prior to treatment of the liquid, and selected minerals may be added to the source liquid to facilitate and enhance crystal formation in the low zeta potential crystal generator, as well as hydrated electron formation in the hydrated electron generator.

The source liquid solution is treated by passage through the low zeta potential crystal generator to modify the crystal structure of minerals in the source liquid solution, providing treated liquid comprising a higher concentration of low zeta potential crystals than that found in the untreated source liquid. The low zeta potential crystals are preferably present in a relatively high concentration in the treated water and are small, preferably in the nano-size range. In a preferred embodiment, treatment of the source liquid in the low zeta potential crystal generator does not substantially alter the elemental composition of the source liquid. In a preferred embodiment, the concentration of elements such as barium, boron, calcium, copper, iron, magnesium, potassium, sodium, and the like in the untreated source liquid is substantially the same as the concentration of those elements in the treated liquid, although the concentration of low zeta potential crystals in the treated liquid is substantially higher than the concentration of low zeta potential crystals in the untreated source liquid.

Prior or subsequent to the treatment of source liquid solution by the low zeta potential crystal generator, the source liquid solution is treated to modify structure of water molecules in the source liquid solution, providing treated liquid comprising a higher concentration of hydrated electrons than that found in the untreated source liquid. The hydrated electrons are preferably present in a relatively high concentration in the treated water.

In one embodiment, the source liquid treated by passage through a low zeta potential crystal generator and the hydrated electron generator, containing a high concentration of low zeta potential crystals and hydrated electrons, is optionally passed through at least one filtration system, whereby bacteria, viruses, cysts, and the like are substantially removed from the treated liquid. Any filtration systems known in the art may be used and incorporated in the inventive system. Filtration systems may include, but are not limited to, particle filters, charcoal filters, reverse osmosis filters, active carbon filters, ceramic carbon filters, distiller filters, ionized filters, ion exchange filters, ultraviolet filters, back flush filters, magnetic filters, energetic filters, vortex filters, chemical oxidation filters, chemical additive filters, Pi water filters, resin filters, membrane disc filters, microfiltration membrane filters, cellulose nitrate membrane filters, screen filters, sieve filters, or microporous filters, and combinations thereof. The treated and optionally filtered liquid may be stored or distributed for use and consumption.

In another embodiment, the treated source liquid, before it reaches the optional filtration system, is optionally passed through a pre-filtration system, whereby minerals, such as iron, sulfur, manganese, and the like, are substantially removed from the treated source liquid. The treated and optionally pre-filtered liquid, containing a high concentration of low zeta potential crystals and hydrated electrons, may then be passed through the optional at least one filtration system, whereby bacteria, viruses, cysts, and the like are substantially removed from the treated and optionally pre-filtered liquid.

In yet another embodiment, after the source liquid passes through the low zeta potential generator, it may optionally pass through a high zeta potential crystal generator before the treated source liquid reaches the hydrated electron generator, whereby high zeta potential crystals are generated.

Any chelating agent, biocidal agent, fungicidal agent, surfactant, inorganic coagulant, polymeric coagulant, hydrophilic colloid known in the art may be added to or incorporated with the source liquid prior to treatment by the inventive system or the treated liquid.

Source liquid treated by the low zeta potential crystal generator, such as the Turbu-Flow™ system, and the hydrated electron generator, such as the NMR Pipetector™, is extremely effective in destroying or reducing growth of cells, pathogens, viruses, bacteria, algae, fungi, spores, and molds, reducing growth of rust, as well as enhancing the overall quality of the source liquids. The low zeta potential crystal generator and the hydrated electron generator may be integrated with various liquid systems to treat many types of source liquid. These liquid systems may include, but are not limited to, water heaters, water coolers, potable water systems, water filtration systems, water sanitation systems, water softeners, ion exchangers, and the like. Liquid systems installed with the low zeta potential crystal generator and the hydrated electron generator can be utilized in residential, commercial, scientific, food processing, medical, dental, hospitals, and industrial settings.

### BRIEF DESCRIPTION OF THE DRAWINGS

The present invention will be described in greater detail in the following detailed description, with reference to the accompanying drawings, wherein:

FIG. 1 shows a scanning electronic microscope (SEM) image of a calcium carbonate crystal obtained from untreated water;

FIG. 2 shows an SEM image of a calcium carbonate crystal obtained from water treated in a Turbu-Flow™ system;

FIG. 3 shows measurement results of zeta potential of particles in untreated water;

FIG. 4 shows measurement results of zeta potential of particles in water treated in a Turbu-Flow™ system;

FIG. 5 shows an embodiment of the inventive liquid system for enhancement of the quality of liquid solutions;

FIG. 6 shows another embodiment of the inventive liquid system for enhancement of the quality of liquid solutions; and

FIG. 7 shows results of a redox (ORP) analysis to determine effect of chlorine addition to untreated water and water treated by the Turbu-Flow™ system.

### DETAILED DESCRIPTION OF THE INVENTION

The system of the present invention may be constructed in a variety of different embodiments and may be employed in connection with enhancing the overall quality of liquid solutions. Water sources, such as tap water, municipal water sources, well water, spring water, wastewater, and the like may be used as source liquid for the inventive system and treated to modify the crystal structure of minerals in the source liquid to produce treated liquid having a high concentration of low zeta potential crystals and hydrated electrons. This treated liquid is highly effective in destroying microorganisms present in the liquid solutions.

The inventive system effectively reduces or eliminates microbial populations in the source liquid without changing the elemental composition of the source liquid and without requiring the use of toxic or harmful additives. The system and process may be implemented in a stationary, installed unit, or in a portable unit. The inventive system may also be retrofit in existing water distribution systems. Although several specific embodiments are described, it will be apparent that the invention is not limited to the embodiments illustrated, and that additional embodiments may also be used.

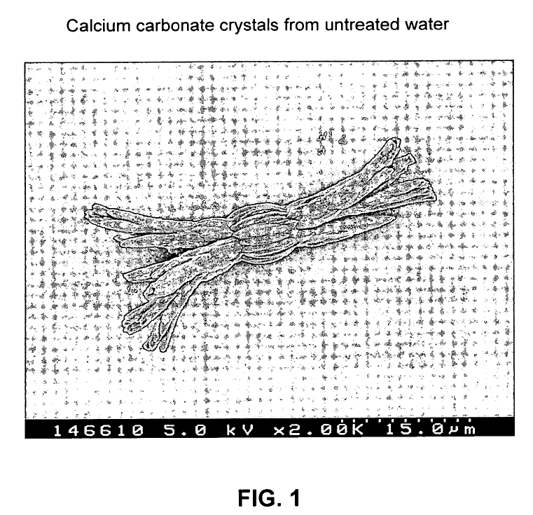

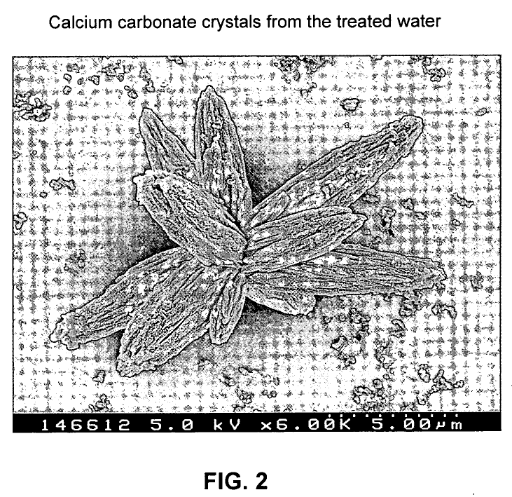

The inventive system incorporates a treatment module comprising a low zeta potential crystal generator, such as the Turbu-Flow™ system. The low zeta potential mineral crystals produced after passage of source liquid through a low zeta potential crystal generator according to the inventive system are of a different structure and nature than the mineral crystals present in untreated liquid sources. FIG. 1 shows a scanning electron microscope (SEM) image of a calcium carbonate crystal obtained from an untreated water sample, and FIG. 2 shows an SEM image of a calcium carbonate crystal obtained from water following treatment in a Turbu-Flow™ system. The crystal structure of the calcium carbonate crystal (aragonite) obtained from water treated in a low zeta potential crystal generator, such as the Turbu-Flow™ system, is dramatically different from the crystal structure of calcium carbonate in the untreated water sample, as evidenced by the images of crystals in the untreated and treated water samples.

Zeta potential is a measurement of the electrical voltage difference between the surface of colloids and its suspending liquid. Zeta potential, measured generally by video under an electron microscope, is related to the actual speed of charged mineral particles in water traveling between an anode and cathode electrode in a direct electrical current field. Zeta potential is thus a direct measurement of electrophoretic mobility (EM). In general, electrophoretic mobility is expressed as microns/second per volts/centimeter. The first term, microns per second, is a velocity measurement. The second term, volts per centimetre, is an expression of the electric field strength. Electrophoretic mobility is, therefore, a relative measure of how fast a charged mineral particle in water moves in an electrical current field.

Zeta potential can be calculated from the measured electrophoretic mobility using a theoretical relation between the two that is dependent on the dielectric constant and the viscosity of the suspending liquid. Zeta potential is generally expressed in millivolts (mV) and generally measures between a range of 0 and +100 mV or 0 and −100 mV. The “plus” or “minus” signs of zeta potential measurements represent the positive or negative traveling direction of the particles in water, respectively, and do not relate to the actual value of the zeta potential. In other words, the value of zeta potential is irrespective of its “sign”. Typical zeta potential of mineral particles in water measures between about −13 mV and −25 mV. The zeta potential of mineral crystals following treatment of the water in a low zeta potential crystal generator generally demonstrates a reduction of value towards 0 mV and measures between about 0 mV and −10 mV.

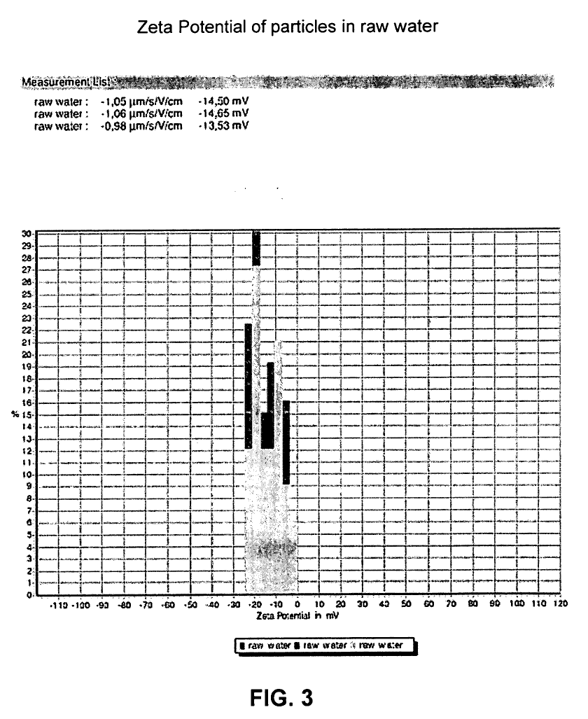

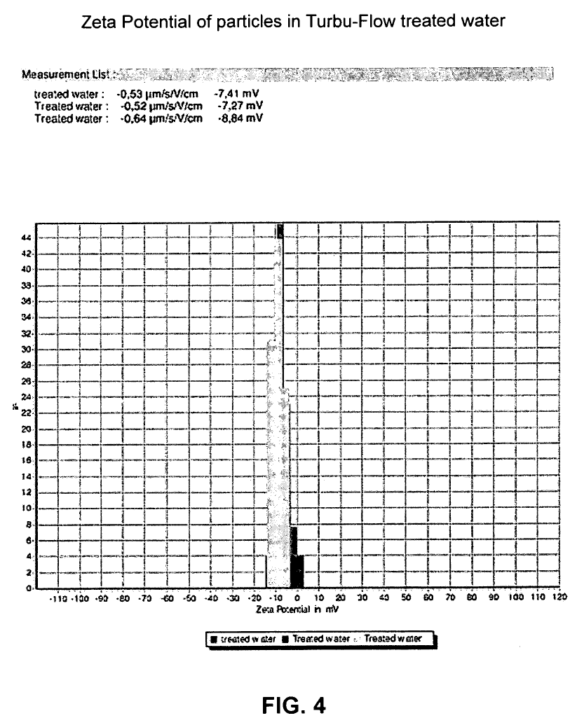

In one study, the zeta potential of mineral particles in untreated water and water from the same source treated by passage through a Turbu-Flow™ low zeta potential crystal generator was measured and compared. Results of the measurements are shown in FIG. 3 (untreated water) and FIG. 4 (treated water). The zeta potential of mineral particles in untreated water was measured, in three samples, as −14.50 mV, −14.65 mV and −13.53 mV. The zeta potential of mineral crystals in water from the same source following treatment by passage through a Turbu-Flow™ system was measured, in three samples, as −7.41 mV, −7.27 mV, and −8.84 mV. The study demonstrates that mineral particles in untreated water generally has a zeta potential measurement between a range of about −12 mV and −15 mV, and passage of the untreated water through a low zeta potential generator such as the Turbu-Flow™ system results in treated water containing mineral crystals that generally have a zeta potential measurement between a range of about −4 mV and −10 mV.

Thus, passage of water through a low zeta potential generator in a system of the present invention reduces the zeta potential of mineral particles by about 20% to 60%. In another embodiment, passage of water through a low zeta potential generator in a system of the present invention reduces the zeta potential of mineral particles by 25%. In yet another embodiment, passage of water through a low zeta potential generator in a system of the present invention reduces the zeta potential of mineral particles by 30%. In yet another embodiment, passage of water through a low zeta potential generator in a system of the present invention reduces the zeta potential of mineral particles by 40%. In still another embodiment, passage of water through a low zeta potential generator in a system of the present invention reduces the zeta potential of mineral particles by 50%. In an alternative embodiment, passage of water through a low zeta potential generator in a system of the present invention reduces the mineral potential of mineral particles by 60%.

The source liquid solution to be treated in the low zeta potential crystal generator or the hydrated electron generator is preferably mildly “hard”, and more preferably quite “hard.” That is, the concentration of calcium carbonate in the source liquid solution is relatively high. The source liquid solution also preferably contains trace amounts of elements including, but are not limited to, Calcium, Titanium, Vanadium, Chromium, Manganese, Iron, Cobalt, Nickel, Copper, Zinc, Molybdenum, Silver, Cadmium, Gold, Platinum, and the like. If the source liquid is deficient in any desired mineral or elemental constituent, minerals and elemental constituents may be added to the source liquid prior to treatment in the low zeta potential crystal generator or the hydrated electron generator.

The currently preferred device for generating low zeta potential crystals is the “Turbu-Flow™” system, which is described above. Other devices for changing the zeta potential of crystals are known in the art or may be developed and used in methods and systems of the present invention.

The currently preferred device for generating hydrated electrons is the “NMR Pipetector™”, which is described above. Other devices for generating hydrated electrons are known in the art or may be developed and used in methods and systems of the present invention. Examples of the other hydrated electron generators include, but are not limited to, AQUA-CORRECT® and AQUA Hydro Physical Systems®, Ecoflow® H2flow® magnetic water conditioner, GMX™ water softeners, Magnetic Magic™ water treatment system, Magna-Tek™ water treatment system, Mundimex™ Magnetizer, Magnetic Solutions™ water treatment system, SpaceAge® magnetic water treatment system, and Superior Water Conditioner®.

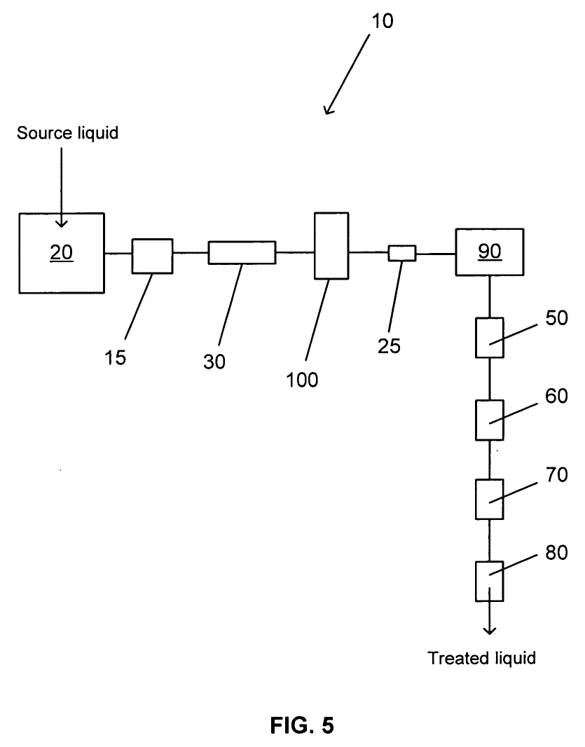

FIG. 5 shows an embodiment of a treatment system 10 for enhancing of the quality of a liquid source material, comprising an optional source liquid pre-treatment system 15, a first low zeta potential crystal generator 30, an optional high zeta potential crystal generator 100, an optional pre-filtration system 50, an optional at least one filtration device 60, a hydrated electron generator 90, and an optional second low zeta potential crystal generator 80. Pre-treatment system 15, low zeta potential crystal generator 30, high zeta potential crystal generator 100, pre-filtration system 50, filtration device 60, hydrated electron generator 90, and second low zeta potential crystal generator 80 are in liquid communication with one another and are connected by way of a conduit system. The conduit system may include, for example, pipes, hoses, tubes, channels, and the like.

Any chelating agent, biocidal agent, fungicidal agent, surfactant, inorganic coagulant, polymeric coagulant, hydrophilic colloid known in the art may be added to or incorporated with the source liquid prior to treatment by the inventive system or the treated liquid.

Treatment system 10 uses source liquid solution having a concentration of calcium carbonate and/or other minerals sufficient to provide a source for generation of low zeta potential crystals and/or hydrated electrons. The source liquid solution, such as water, is supplied from any suitable source and may be stored in a reservoir 20, or may be supplied continuously or intermittently from any source. The composition of source liquid may be tested and, if necessary, additional minerals and other constituents may be added to provide a sufficient source for generation of low zeta potential crystals and/or hydrated electrons. The source liquid may also be treated, prior or subsequent to holding in reservoir 20, in pre-treatment system 15 to substantially remove unwanted contaminants that may interfere with the treatment process, such as debris, oil-containing constituents, and the like.

Source liquid may be added continuously or intermittently to liquid reservoir 20, and the liquid may be released using a passive system, or actively pumped, towards low zeta potential crystal generator 30 or hydrated electron generator 90. As described above, various systems are available for enhancing the zeta potential crystal and hydrated electron concentration of liquids and any such systems may be used as low zeta potential crystal generator 30 and hydrated electron generator 90.

Treated liquid, after passage through low zeta potential crystal generator 30, contains a high concentration of low zeta potential crystals. In one embodiment, the zeta potential of mineral crystals in liquid following treatment in the low zeta potential crystal generator 30 is between 0 mV and −10 mV. In another embodiment, the zeta potential of mineral crystals in liquid following treatment in the low zeta potential crystal generator 30 is between −4 mV and −10 mV. In yet another embodiment, the zeta potential of mineral crystals in liquid following treatment in the low zeta potential crystal generator 30 is between −5 mV and −9 mV. The “plus” or “minus” signs of zeta potential measurements represent the positive or negative traveling direction of the mineral crystals, respectively, and do not relate to the actual value of the zeta potential. In other words, the value of zeta potential is irrespective of its “sign”.

In this embodiment, source liquid may be first added continuously or intermittently to liquid reservoir 20, and the liquid may be released using a passive system, or pumped, towards low zeta potential generator 30, where low zeta potential crystals are generated. As described above, various systems are available for enhancing the zeta potential crystal concentration of liquids and any such systems may be used. In the embodiment as shown in FIG. 5, pump 25 is provided downstream from low zeta potential generator 30 and treated liquid is released intermittently or continuously for various liquid system applications. Pump 25 may alternatively be provided upstream from low zeta potential generator 30. The low zeta potential crystals generated by low zeta potential generator 30 do not settle readily and generally stay in suspension for a long period, even without agitation of the solution. In this embodiment of the inventive liquid system, liquid treated by low zeta potential generator 30, having a high concentration of low zeta potential mineral crystals, is further treated by hydrated electron generator 90, wherein hydrated electrons are generated. The twice treated liquid contains a high concentration of low zeta potential mineral crystals and hydrated electrons.

In another embodiment, source liquid is first treated by hydrated electron generator 90, wherein hydrated electrons are generated. Liquid treated by hydrated electron generator 90, having a high concentration of hydrated electrons, is further treated by low zeta potential crystal generator 30 as described above, wherein low zeta potential mineral crystals are generated. The twice-treated liquid contains a high concentration of hydrated electrons and low zeta potential mineral crystals.

In yet another embodiment, the inventive system is capable of alternating and repeating treatments of source liquid. In this embodiment, source liquid is first treated by a first hydrated electron generator 90, wherein hydrated electrons are generated. The treated liquid is next treated by low zeta potential generator 30, wherein low zeta potential mineral crystals are generated. The twice-treated liquid is further treated by a second hydrated electron generator (not shown), wherein additional hydrated electrons are generated. The thrice-treated liquid contains a high concentration of hydrated electrons and low zeta potential mineral crystals.

In still another embodiment, source liquid is first treated by a first low zeta potential crystal generator 30, wherein low zeta potential mineral crystals are generated. The treated liquid is next treated by hydrated electron generator 90, wherein hydrated electrons are generated. The twice-treated liquid is further treated by a second low zeta potential crystal generator 30, wherein additional low zeta potential mineral crystals are generated. The thrice-treated liquid contains a high concentration of low zeta potential mineral crystals and hydrated electrons.

In an alternative embodiment, after source liquid is treated by low zeta potential crystal generator 30 and hydrated electron generator 90, the treated source liquid is passed through at least one filtration device 60. Filtration device 60 reduces or substantially eliminates bacteria, viruses, cysts, and the like. Any filtration devices known in the art may be used. Filtration device 60 may include, but is not limited to any of the following devices: particle filters, charcoal filters, reverse osmosis filters, active carbon filters, ceramic carbon filters, distiller filters, ionized filters, ion exchange filters, ultraviolet filters, back flush filters, magnetic filters, energetic filters, vortex filters, chemical oxidation filters, chemical addictive filters, Pi water filters, resin filters, membrane disc filters, microfiltration membrane filters, cellulose nitrate membrane filters, screen filters, sieve filters, or microporous filters, and combinations thereof. The treated and filtered liquid may be stored or distributed for use and consumption.

In another alternative embodiment, after source liquid is treated by low zeta potential crystal generator 30 and hydrated electron generator 90, and before reaching the optional at least one filtration device 60, the treated liquid may optionally be passed through a high zeta potential crystal generator 100. High zeta potential crystal generators are known in the art and generally useful for prevention or reduction of scaling. In addition, high zeta potential crystal generator 100 keeps low zeta potential crystals generated by low zeta potential crystal generator 30 suspended in the treated liquid and will not reduce the zeta potential of the generated low zeta potential crystals. One known high zeta potential crystal generator 100 is the Zeta Rod® system. The Zeta Rod® system increases zeta potential of crystals by electronically dispersing bacteria and mineral colloids in liquid systems, eliminating the threat of bio-fouling and scale and significantly reducing use of chemical additives. Colloids in liquid systems become components of the capacitor and receive a strong boost to their natural surface charge, altering double-layer conditions that govern particle interactions. Mineral scale formation is prevented as the Zeta Rod® system stabilizes the dispersion of colloidal materials and suspended solids, preventing nucleation and attachment of scale to wetted surfaces. Bacteria remain dispersed in the bulk fluid rather than attaching to surfaces, and cannot absorb nutrition or replicate to form slime and create foul odors. Existing biofilm hydrates excessively, loses bonding strength and disperses. Also, biological fouling, biocorrosion, and scale formation are arrested by the Zeta Rod® system.

Another known high zeta potential crystal generator 100 is the Sterling Water Anti-Scale Appliance manufactured by Sterling Water Systems, LLC, a subsidiary of Porta Via Water Company. As water passes through the Sterling Water Anti-Scale Appliance, an electrical current is discharged into the water, which decreases the water's surface tension and inhibits the formation of scale and hard water spots from appearing. The inhibition of scale formation is due to the increase of zeta potential of crystals in the treated water, which keeps mineral particles from coming in contact with one another.

In still another alternative embodiment, after passage through low zeta potential crystal generator 30, hydrated electron generator 90, and the optional high zeta potential crystal generator 100, and before reaching the optional at least one filtration device 60, the treated liquid may optionally be passed through pre-filtration system 50, wherein minerals, such as iron, sulphur, manganese, and the like are substantially removed from the treated source liquid. Pre-filtration system 50 can be, for example, a stainless steel mesh filter. The treated and pre-filtered source liquid, is next passed through the optional at least one filtration device 60, wherein bacteria, viruses, cysts, and the like are substantially removed from the treated liquid.

The treated liquid, containing a high concentration of low zeta potential crystals and hydrated electrons, may be distributed to and stored in a storage container 70, such as a reservoir.

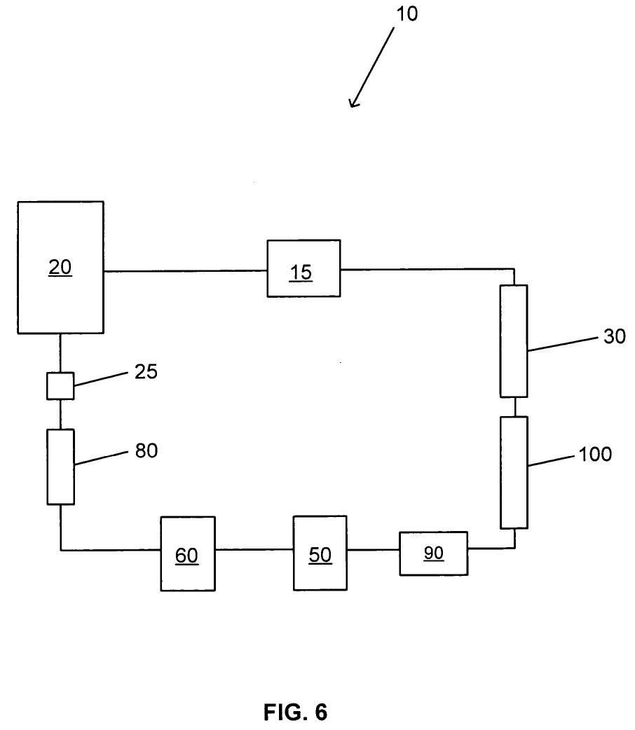

FIG. 6 shows another embodiment of the inventive system 10. The system 10 comprises a source reservoir 20 that houses the source liquid, an optional source liquid pre-treatment system 15, a first low zeta potential crystal generator 30, a hydrated electron generator 90, an optional high zeta potential crystal generator 100, an optional pre-filtration system 50, an optional at least one filtration device 60, and an optional second low zeta potential crystal generator 80. Pre-treatment system 15, low zeta potential crystal generator 30, hydrated electron generator 90, high zeta potential crystal generator 100, pre-filtration system 50, filtration device 60, and second low zeta potential crystal generator 80 are in liquid communication with one another and are connected by way of a circulating conduit system. Examples of source reservoir 20 may include, but are not limited to, steam boilers, water heaters, cooling towers, drinking water tanks, pools, contained aquaculture ponds, aquariums, industrial water supply reservoirs, garden ponds, and the like. Source liquid may be stored or added continuously or intermittently to source reservoir 20, and the source liquid may be released using a passive system, or pumped, towards low zeta potential crystal generator 30, where low zeta potential mineral crystals are generated, and hydrated electron generator 90, where hydrated electrons are generated. Alternatively, the source liquid may be treated, prior or subsequent to holding in source reservoir 20, in pre-treatment system 15 to remove unwanted contaminants that may interfere with the treatment process, such as debris and oil-containing constituents.

In the embodiment shown in FIG. 6, source liquid stored in source reservoir 20, pre-treatment system 15, low zeta potential crystal generator 30, hydrated electron generator 90, high zeta potential crystal generator 100, pre-filtration system 50, filtration device 60, second low zeta potential crystal generator 80, and pump 25 are connected in a loop-like manner by conduit system. Exemplary conduit systems may include, but are not limited to, pipes, hoses, tubes, channels, and the like, and may be exposed to the atmosphere or enclosed. This circulatory or loop-type connection provides continuous or intermittent circulation of the source liquid through source reservoir 20, pre-treatment system 15, low zeta potential crystal generator 30, hydrated electron generator 90, high zeta potential crystal generator 100, pre-filtration system 50, filtration device 60, and second low zeta potential crystal generator 80.

Continuous or intermittent treatment of the source liquid by low zeta potential crystal generator 30 and hydrated electron generator 90, eventually arrives at a point in time where the entire volume of the source liquid within the system 10 is treated by low zeta potential crystal generator 30 and hydrated electron generator 90. In other words, the entire inventive system 10 eventually comes to an equilibrium-like state, where the entire volume of the liquid within the system 10 is treated to generate low zeta potential mineral crystals and hydrated electrons. The low zeta potential mineral crystals generated by low zeta potential crystal generator 30 generally settle in a low turbulence area of source reservoir 20 over time. The settling crystals form a layer of soft deposit that can be readily cleaned or removed from the system 10.

Before passing through the optional filtration device 60, the treated liquid, containing a high concentration of low zeta potential crystals and hydrated electrons, may optionally be passed through high zeta potential crystal generator 100 for generating high zeta potential crystals to substantially remove minerals that can cause the formation of scale.

Treated liquid, after passage through low zeta potential crystal generator 30, hydrated electron generator 90, and the optional high zeta potential crystal generator 100, may optionally be passed through pre-filtration system 50, wherein minerals, such as iron, sulphur, manganese, and the like are substantially removed from the treated source liquid.

In an alternative embodiment, as shown in FIG. 6, after passage through the optional filtration device 60, treated liquid may be passed through an optional second low zeta potential crystal generator 80 for generating additional low zeta potential mineral crystals. In this embodiment, the continuous and intermittent treatment of the source liquid by the first low zeta potential crystal generator 30 and second low zeta potential crystal generator 80 eventually arrives at a point in time where the entire volume of the source liquid within the system 10 is treated by first low zeta potential crystal generator 30 and second low zeta potential crystal generator 80.

The inventive system shown in FIG. 6 is capable of alternating and repeating treatments of source liquid. In this embodiment, source liquid is first treated by a first hydrated electron generator 90, wherein hydrated electrons are generated. The treated liquid is next treated by low zeta potential generator 30, wherein low zeta potential mineral crystals are generated. The twice-treated liquid is further treated by a second hydrated electron generator (not shown), wherein additional hydrated electrons are generated. Alternatively, source liquid may be first treated by a first low zeta potential crystal generator 30. The treated liquid is next treated by hydrated electron generator 90, and the twice-treated liquid is further treated by a second low zeta potential crystal generator 80.

It has also been observed that liquid treated by the inventive system inhibits and reverses the growth of biofilm. It is thought that the change in crystal structure leaves no place to the microorganisms to attach. Also, the change in zeta potential modifies the interaction between particles and cell membrane because the nano size low zeta potential crystals could cross the cell membrane of the micro organisms and destroy the cell.

It has also been observed that water treated by the system 10 stops and reverses the growth of biofilm. It is thought that the change in crystal and water structure leaves no place to the microorganisms to attach. Also, the change in zeta potential and generation of hydrated electrons modify the interaction between particles and cell membrane because the low zeta potential crystals and hydrated electrons could cross the cell membrane of the microorganisms and destroy the cell. It has further been observed that water treated by the inventive system and method prevents the growth of iron bacteria in the treated source liquid.

Applications of the Inventive System

The inventive system equipped with a low zeta potential crystal generator 30 such as the Turbu-Flow™ system may be used to eliminate bacteria and microorganisms and enhance the over quality of liquid in a number of liquid systems. These liquid systems, described in more details below, may include, but are not limited to, water heaters, water coolers, potable water systems, food processing settings, household water filtration systems, sanitation settings, water softeners, ion exchangers, and medical, dental, and industrial water supply lines, and the like.

Water Heating Systems

The low zeta potential crystal generator 30 such as Turbu-Flow™ system may be integrated with various water heating systems. It has been unexpectedly discovered that water treated by a water heating system provided with the low zeta potential crystal generator 30 can eliminate bacteria and microorganisms in water, thereby improving the heat transfer efficiency of water heating systems. The liquid heating systems benefiting from the inventive system may include, but are not limited to, continuous water heaters, gas-fuelled hot water tank type heaters, electric hot water tank type heaters, re-circulating hot water systems for hot water tanks, continuous water heaters, district heating systems, in-floor heating systems, heat exchangers that utilities hot water and/or steam, or in combination with heat transfer liquids, such as hot oils natural or synthetic.

Water Cooling Systems

The low zeta potential crystal generator 30 such as Turbu-Flow™ system may be integrated with various water cooling systems. It has been unexpectedly discovered that water treated by a water cooling system provided with a low zeta potential crystal generator 30 such as Turbu-Flow™ system, can eliminate bacteria and microorganisms in liquids, thereby improving the cooling transfer efficiency. The water cooling systems may include, but are not limited to, continuous water coolers, refrigerators, gas and electrically fired evaporators, cooling pads, wet film evaporators, evaporative cooling systems, ground source cooling systems, lake or river water cooling systems, heat exchange cooling systems for lakes, grounds, rivers, or ocean waters, district cooling systems, re-circulating cooling systems, in-floor cooling systems, cooling towers all types makes and models, vacuum applications for industrial cooling on boilers, sugar plant cooking pans, paper mills, petroleum refining plants, mining plants, power plants including: coal, gas, oil, biomass, and nuclear.

Potable Water Systems

The low zeta potential crystal generator 30 such as Turbu-Flow™ system may be integrated with various potable water systems. It has been discovered that water treated in system incorporating a low zeta potential crystal generator such as Turbu-Flow™ system, can eliminate bacteria and microorganisms in, and enhance quality of, water, thereby preventing the formation of biofilm in various piping systems, as well as improving the taste of water. The potable water systems may include, but are not limited to, wells, springs, ponds, lakes, rivers, and the like.

Food Processing Industry

It has been unexpectedly discovered that water treated by a system incorporating a low zeta potential crystal generator, such as a Turbu-Flow™ system, can act as a disinfectant with the addition a minimal amount of chlorine (under 5 ppm) for storage of fresh produce. Since the treated water has been discovered to eliminate biofilm formation, food sanitation and production costs are lower and shelf life is lower. Further, since lower water surface tension increases solvency of the treated water, water treated in a system incorporating a low zeta potential crystal generator, such as a Turbu-Flow™ system, greatly increases the yield of oils from teas and coffees.

Sanitation Applications

Low zeta potential crystal generators, such as Turbu-Flow™ system, can be integrated with sanitation systems such as swimming pools, power washers, car washes, household washing machines, commercial laundry facilities, household and commercial dishwashing facilities, and the like.

Water Treatment Applications

Low zeta potential crystal generators, such as Turbu-Flow™ system, can be integrated with water treatment applications such as water softeners, ion exchangers, all membrane and filter systems that utilize chlorine, chlorine dioxide, hydrogen peroxide, ozone, and the like.

Medical Industry

Low zeta potential crystal generators, such as Turbu-Flow™ system, can be integrated with medical systems and the systems are useful in applications related generally to skin treatments through bathing, spas, and daily usage, improved calcium uptake, improved teeth and conditions, as well as medical, dental, and industrial water lines.

Household Water Filtration Systems

Household water filtration systems equipped with a low zeta potential crystal generator, such as the Turbu-Flow™ system, are capable of converting mineral ions to nano size low zeta potential mineral crystals, resulting in an ultra filtration system for the removal of minerals, such as calcium, in water systems for use in the common household. The Turbu-Flow™ system has also been found to achieve superior reverse osmosis membrane performances due to the lower zeta potential mineral crystals in the treated water. The treated minerals in the treated water solutions increase the efficiency of coagulation and flocculation. Flocculants and coagulants are normally chemical compounds such as poly-electrolytes, ferric sulphate, aluminium sulphate, which are used in various clarification processes that often involve dissolved air flotation devices of various designs. The advantage of the treated water in water systems for use in the common household is use of less chemical and better process, which increases water filtration efficiency.

In addition, it has been unexpectedly discovered that iron FE₃ can be converted to Iron FE₂ at low levels in water treated in a low zeta potential crystal generator, which greatly improves oil and water separation due to the lower surface tension of the treated water. Furthermore, it has been found that bacteria and microorganisms present in treated water are converted to nano-size low zeta potential mineral crystals, which can be readily cleaned or removed from the water filtration system.

A low zeta potential crystal generator such as the Turbu-Flow™ system for use in the common household may be integrated with any filtration device 60 known in the art as described above.

### Devices Incorporating Systems and Methods of the Present Invention

It is obvious that methods and systems of the present invention can be used in conjunction with or retrofit in existing devices and liquid distribution systems, such as water heating systems including, but are not limited to, continuous water heaters, gas-fuelled hot water tank type heaters, electric hot water tank type heaters, re-circulating hot water systems for hot water tanks, continuous water heaters, district heating systems, in-floor heating systems, heat exchangers that utilities hot water and/or steam, or in combination with heat transfer liquids, such as hot oils natural or synthetic; water cooling systems including, but are not limited to, continuous water coolers, refrigerators, gas and electrically fired evaporators, cooling pads, wet film evaporators, evaporative cooling systems, ground source cooling systems, lake or river water cooling systems, heat exchange cooling systems for lakes, grounds, rivers, or ocean waters, district cooling systems, re-circulating cooling systems, in-floor cooling systems, cooling towers all types makes and models, vacuum applications for industrial cooling on boilers, sugar plant cooking pans, paper mills, petroleum refining plants, mining plants, power plants including: coal, gas, oil, biomass, and nuclear; potable water systems including, but are not limited to, wells, springs, ponds, lakes, rivers, and the like; food processing applications such as coffee and tea; sanitation systems including, but are not limited to, swimming pools, power washers, car washes, household washing machines, commercial laundry facilities, household dishwashers and commercial dishwashing facilities, and the like; water softeners; ion exchangers; all membrane and filter systems that utilize chlorine, chlorine dioxide, hydrogen peroxide, ozone, and the like; skin treatment systems through bathing, spas, and daily usage, improved calcium uptake, improved teeth and conditions; medical, dental, and industrial water lines; and any household water filtration systems

### EXAMPLE 1

### Chemical Analysis of Untreated and “Turbu-Flow™” Treated Water

A chemical analysis comparing the wet chemistry and elemental metal composition of untreated, “raw” water and water treated in a low zeta potential generator, such as the Turbu-Flow™ system is shown below in Table 1. The instrument detection limits are also provided. According to the results shown in Table 1, very little change can be detected in treated water, except that an increase in turbidity (a measure of the cloudiness of water caused by suspended particles) is observed.

TABLE 1

| | | Instrument | | |
|---|---|---|---|---|
| | | Detection | Untreated | Treated |
| | | Limit | Water | Water |
| Wet Chem. | Conductivity (us/cm) | 3 | 720 | 720 |
| | pH (pH units) | 0.1 | 7.8 | 7.7 |
| | Turbidity (NTU) | 0.10 | 0.30 | 0.50 |
| Metals | Aluminum (mg/L) | 0.01 | 0.02 | 0.02 |
| | Barium (mg/L) | 0.01 | 0.08 | 0.08 |
| | Beryllium (mg/L) | 0.001 | <0.001 | <0.001 |
| | Boron (mg/L) | 0.05 | <0.05 | <0.05 |
| | Cadmium (mg/L) | 0.0001 | <0.0001 | <0.0001 |
| | Calcium (mg/L) | 0.5 | 84 | 85 |
| | Chromium (mg/L) | 0.001 | 0.001 | 0.001 |
| | Cobalt (mg/L) | 0.0008 | <0.0008 | <0.0008 |
| | Copper (mg/L) | 0.001 | 0.059 | 0.052 |
| | Iron (mg/L) | 0.05 | 0.11 | 0.11 |
| | Lead (mg/L) | 0.001 | <0.001 | <0.001 |
| | Magnesium (mg/L) | 0.5 | 20 | 20 |
| | Manganese (mg/L) | 0.001 | 0.004 | 0.004 |
| | Molybdenum (mg/L) | 0.001 | <0.001 | <0.001 |
| | Nickel (mg/L) | 0.002 | <0.002 | <0.002 |
| | Potassium (mg/L) | 0.5 | 1.9 | 1.9 |
| | Silver (mg/L) | 0.0001 | <0.0001 | <0.0001 |
| | Sodium (mg/L) | 0.5 | 19 | 20 |
| | Strontium (mg/L) | 0.001 | 0.24 | 0.24 |
| | Thallium (mg/L) | 0.0003 | <0.0003 | <0.0003 |
| | Uranium (mg/L) | 0.005 | <0.005 | <0.005 |
| | Vanadium (mg/L) | 0.001 | 0.003 | 0.003 |
| | Zinc (mg/L) | 0.003 | 0.004 | 0.004 |
| | Zirconium (mg/L) | 0.001 | <0.001 | <0.001 |

### EXAMPLE 2

### Kill Time Study

The following table illustrates the kinetics of the destruction of microorganisms using steam vapor application according to the present invention. This example shows that regular tap water treated by the Turbu-Flow system results in an equivalent level of decontamination as sterile, deionized water.

Inoculum Preparation:

Cultures of S. aureus ATCC #6538 and L. monocytogenes ATCC #19111 were transferred from stock cultures to individual tubes of Soybean casein digest broth (SCDB) media. Cultures were incubated at 30-35° C. for 24-48 hours.

A. niger ATCC #16404 was inoculated onto Sabouraud dextrose agar (SDEX) and incubated at 20-25° C. for 6-10 days. A. niger was harvested by removing the mycelial mats from the surface using a sterile spatula. The mycelia were placed into a sterile funnel containing moist cotton and rinsed with SALT, a solution of 0.9% saline with 0.05% Tween. Organism concentration was adjusted in Physiological Saline Solution (PHSS) to produce a challenge level of approximately 10⁶⁻⁷ CFU/mL using visual turbidity.

A. niger is a fungus commonly found on textiles, in soils, grains, fruits, and vegetables and is a common cause for skin, pulmonary, and ear infections. S. aureus is a spherical bacterium and a common inhabitant of human skin. L. monocytogenes is a gram-positive, motile, rod-shaped bacterium that is found principally in contaminated food products.

Sample Preparation:

Samples were tested as received without any additional dilution or manipulation.

Test Procedure:

Tubes containing 9 mL of each test sample were brought to 50+/−2° C. in a waterbath. One mL of the prepared test microorganism suspension was added to each tube containing the test sample to yield a minimum of 1×10⁵ CFU/mL challenge organism. The samples were mixed by swirling. The tubes were placed back into the waterbath. At 50° C., 60° C., 70° C., 80° C., and 90° C. (all temperatures within +2° C.) exposure temperatures 1.0 mL aliquots of sample solution-cell suspension were removed and added to 9 mL of Letheen broth (LETH). The tubes were mixed thoroughly. Ten-fold serial dilutions were made in blanks containing 9 mL of LETH through the appropriate dilution. Triplicate aliquots were plated from selected dilutions onto Soybean casein digest agar (SCDA) for S. aureus and L. monocytogenes samples and SDEX for A. niger samples. Bacterial plates were incubated at 30-35° C. for 48-72 hours and mold plates were incubated at 20-25° C. for 3-7 days.

Positive Control:

Tubes were prepared containing 9 mL of sterile deionized water at 200 ppm hard water for each organism type. The tubes were equilibrated to 50+2° C. At T═O, 1 mL of test organism was added to the tube. Aliquots of the control were removed at the same temperature and relative time points as the test sample. Ten-fold serial dilutions were prepared in dilution blanks containing 9 mL of LETH. Triplicate aliquots were plated from selected dilutions onto Soybean casein digest agar (SCDA) for S. aureus and L. monocytogenes samples and SDEX for A. niger samples. Bacterial plates were incubated at 30-35° C. for 48-72 hours and mold plates were incubated at 20-25° C. for 3-7 days.

Acceptance Criteria:

Positive controls must demonstrate a titer of ≧10⁵ CFU/mL. Negative controls must not show any growth of the test organism.

Results:

The percent reduction and log reduction results in Table 4 show that tap water treated in the Turbu-Flow™ system to produce water having a high concentration of low zeta potential crystals has at least the equivalent ability to reduce growth of various fungi, bacteria and spores as deionized water. Negative controls did not show growth of the test microorganisms. The data as shown in Table 4 also demonstrates that tap water treated by the Turbu-Flow system has superior ability to reduce growth of microorganisms than that of deionized water at lower temperature (50° C.).

TABLE 2

| Organism | Temperature | Percent reduction | Log₁₀ reduction |
|---|---|---|---|
| A. niger | 50° C. | 47 | 0.28 |
| Treated water | 60° C. | 81 | 0.72 |
| | 70° C. | 99.9989 | 4.97 |
| | 80° C. | 99.9989 | 4.97 |
| | 90° C. | 99.9989 | 4.97 |
| A. niger | 50° C. | 0 | 0 |
| Deionized water | 60° C. | 84 | 0.8 |
| (Control) | 70° C. | 99.9989 | 4.57 |
| | 80° C. | 99.9989 | 4.97 |
| | 90° C. | 99.9989 | 4.97 |
| S. aureus | 50° C. | 20 | 0.1 |
| Treated water | 60° C. | 56 | 0.36 |
| | 70° C. | 99.9956 | 4.36 |
| | 80° C. | 99.99959 | 5.39 |
| | 90° C. | 99.99959 | 5.39 |
| S. aureus | 50° C. | 0 | 0 |
| Deionised water | 60° C. | 99.959 | 3.39 |
| (Control) | 70° C. | 99.99959 | 5.39 |
| | 80° C. | 99.99904 | 5.02 |
| | 90° C. | 99.99959 | 5.39 |
| L. monocytogenes | 50° C. | −310 | −0.61 |
| Treated water | 60° C. | 37 | 0.20 |
| | 70° C. | 99.989 | 3.97 |
| | 80° C. | 99.989 | 3.97 |
| | 90° C. | 99.989 | 3.97 |
| L. monocytogenes | 50° C. | 0 | 0 |
| Deionised water | 60° C. | 98.9 | 1.97 |
| (Control) | 70° C. | 99.989 | 3.97 |
| | 80° C. | 99.989 | 3.97 |
| | 90° C. | 99.989 | 3.97 |

### EXAMPLE 3

### Water Surface Tension Analysis

Samples of untreated water and water treated by passage through a low zeta potential crystal generator were generated and analyzed for surface tension at room temperature and at 80° C. The results of the analysis are summarized in Table 3.

TABLE 3

| | Untreated Water | | Turbu-Flow Treated Water | |
|---|---|---|---|---|
| Date | Room Temp | 80° C. | Room Temp | 80° C. |
| May 5, 2004 | 79.0 dynes/cm | na | 69.5 dynes/cm | na |
| May 25, 2004 | 79.1 dynes/cm | 69.2 | 77.4 dynes/cm | 67.5 |
| | | dynes/cm | | dynes/cm |

Table 3 shows a dramatic decrease in water surface tension after a single pass through the Turbu-Flow™ system. The sample was analyzed approximately one week later. Based on a one-week-old sample, the surface tension dropped from 79.0 dynes/cm in the untreated water to 69.3 dynes/cm in the water treated by the Turbu-Flow™ system.

To further delineate the impact of time and temperature on the surface tension, the analysis was repeating almost three weeks later. At this time, the treated water sample exhibited only a slight decrease in surface tension over the untreated water at both room temperature and at 80° C. This analysis demonstrates that water treated by the Turbu-Flow™ system will revert back to its original surface tension over time. The most significant findings of this experiment is that for a period of more than a week after the water sample is passed through the Turbu-Flow™ system, it exhibited a surface tension that is similar in magnitude to water that has been heated to 80° C.

Thus, the water treated by the Turbu-Flow™ system has the ability to cause microorganisms to be less heat-tolerant due to the lower surface tension of the treated water.

### EXAMPLE 4

### Comparison of Water Characteristics Over Time

On Jul. 19, 2004, a sample of tap water treated by the Turbu-Flow™ system from Jun. 29, 2004 was submitted for analysis along with a tap water sample treated by passage through a Turbo-Flow™ system on Jul. 19, 2004. The results of these analyses are summarized in Table 4 below.

TABLE 4

| | Treated - | Initial Tap Water | Treated - |
|---|---|---|---|
| | June 29 | July 19^{th} | July 19^{th} |
| pH (pH units) | 6.63 | 7.89 | 7.16 |
| Turbidity (NTU) | 0.91 | 0.17 | 0.45 |
| Colour - Apparent (TCU) | <1 | 1 | 5 |

The results in Table 4 demonstrate that water treated by the Turbu-Flow™ system collected on Jun. 29, 2004 had a significantly depressed pH compared to the untreated and treated samples of Jul. 19, 2004. Also, the turbidity and the color of the three week old treated water sample are higher than that of the untreated water. The increase in turbidity and color of a three week old water sample that was treated by the Turbu-Flow™ system had not been previously observed.

### EXAMPLE 5

### Redox (ORP) Analysis to Determine Effect of Chlorine Addition

ORP (Oxidation Reduction Potential) or Redox is used in pool water treatment as an indication of sanitation in relation to free chlorine parameter. ORP technology is found to be a reliable indicator of bacteriological water quality. It is generally necessary for water to have an ORP value of at least 700 mV to ensure good water quality.

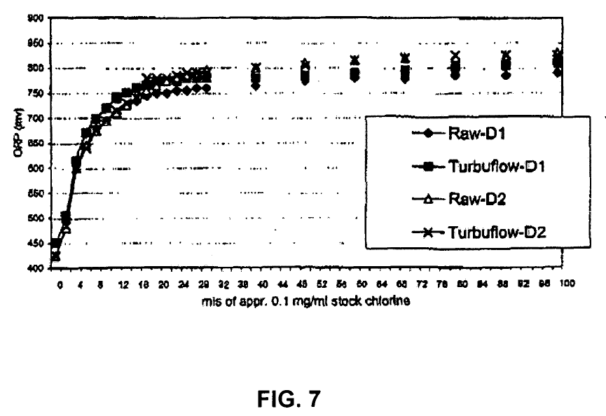

Samples of untreated and tap water treated by the Turbu-Flow™ system were submitted to determine the effect of chlorine addition on both sample types. The results are presented in FIG. 7.

FIG. 7 shows that on the day the samples were generated (Day 1 or D1 on the graph), the water treated by Turbu-Flow™ system required less of the standard chlorine solution to achieve an elevated ORP. FIG. 7 also shows that, by the next morning, both the untreated and treated samples were comparable to the results of the treated samples from Day 1. Furthermore, other that a slight difference in the early stages, both Day 2 samples exhibited almost identical ORP response to chlorine addition.

### EXAMPLE 6

### Study on the Effect of Turbu-Flow™ System on Iron Precipitation and Biofilm Formation

This example illustrates a study on the effect of the Turbu-Flow™ system on calcium carbonate deposition by measured the size of the calcium carbonate crystals in water before and after treatment through a Turbu-Flow™ system. The results showed that one of the observed crystals had changed from a typical calcite to an aragonite structure. Chemical analysis of various metals, conductivity, and pH had shown no measurable difference between the raw and Turbu-Flow™ treated water. However, the turbidity had increased from 0.3 to 0.5 NTU, which was attributed to the restructuring of the calcium carbonate crystals. The study also observed that water treated with the Turbu-Flow™ system had eliminated biofilm growth.

Methodology

A specific sampling and analytical methodology was developed to evaluate the performance of the Turbu-Flow™ units for each of the areas of concerns; calcium carbonate deposition, iron precipitation, and biofilm growth.

Calcium Carbonate Deposition

To measure the effect of the Turbu-Flow™ unit on calcium carbonate deposition in the water piping, water samples were collected upstream and downstream of the installed Turbu-Flow™ units and sent to a laboratory for analysis of total suspended solids (TSS). The total suspended solids (TSS) are defined as those particles that are larger than two microns based on standard methods. Based on the Turbu-Flow™ design information, the average crystal size downstream of the Turbu-Flow™ unit should be larger than those upstream of the unit, resulting in an overall increase of total suspended solids downstream of the Turbu-Flow™ unit.

Iron Precipitation

To evaluate the effect of the Turbu-Flow™ system on increasing iron precipitation, water samples were collected upstream and downstream of the installed Turbu-Flow™ units and analyzed for dissolved iron and ferrous iron (Fe₂). Furthermore, swab samples on the inside of the pipe surface were collected and analyzed for the presence or absence of iron bacteria. Dissolved iron is the total iron in solution larger than 0.45 microns based on standard methods. If the Turbu-Flow™ unit accelerates the precipitation of the iron, then there should be a reduction in the dissolved iron concentration subsequent to the Turbu-Flow™ unit. Similarly, there should be a reduction in the concentration of dissolved ferrous iron in solution subsequent to the Turbu-Flow™ unit.

Biosolids Growth

To evaluate the effect of the Turbu-Flow™ unit on inhibiting biofilm growth, swab samples on the interior surface of the pipe upstream and downstream of the Turbu-Flow™ unit were collected and analyzed for total aerobic bacteria plate count.

Sampling Program

Water and swab samples were collected upstream and downstream of Turbu-Flow™ units on Dec. 5 and 6 2005 at 8 different locations, including 5 homes, a maple leave hatchery (MLH), and 2 farms. Additional swab samples from the inside the cartridge filters downstream of the Turbu-Flow™ units were also collected to determine if there was any biofilm growth. When two or more cartridge filter assemblies were present, samples from the first unit downstream of the Turbu-Flow™ were collected. Details on the specific number and type of samples collected from each location are presented in Table 5. Table 5 presents the results of total suspended solids in the water samples upstream and downstream of the Turbu-Flow™ units collected on Dec. 6 and 7, 2005.

TABLE 5
Total Suspended Solids for Water Samples Upstream
and Downstream of the Turbu-Flow ™ Units

| | Total Suspended | Solids (mg/Location L) |
|---|---|---|
| Location | Upstream | Downstream |
| Home 1 | 6 | 6 |
| Home 2 | <1 | <1 |
| Home 3 | <1 | 2 |
| Home 4 | <1 | <1 |
| Home 5 | <1 | <1 |
| Farm 1 | 2 | 6 |
| Farm 2 | 6 | 6 |

On average, there was no measurable difference between the upstream and downstream water samples for total suspended solids (TSS), with the exception of Home 3 and Farm 1. At both these locations, there was a slight increase in the total suspended solids.

Table 6 presents the dissolved iron, ferrous iron, and iron bacteria results upstream and downstream of the Turbu-Flow™ units from the samples collected on Dec. 6 and 7, 2005. As shown in Table 6, both the dissolved and ferrous iron concentrations were measured below the laboratory analytical detection limit, with the exception of ferrous iron in Farm 2. The ferrous iron concentration increased subsequent to the Turbu-Flow™ unit. Therefore, the effect of the Turbu-Flow™ on accelerating iron flocculation cannot be determined. However, a significant result is that at locations upstream of the Turbu-Flow™ unit where the presence of iron bacteria was detected, there was an absence of iron bacteria downstream of the Turbu-Flow™ unit. This suggests that the Turbu-Flow™ inhibits iron bacteria formation.

TABLE 6
Dissolved Iron, Ferrous Iron, and Iron Bacteria in the Samples Collected
Upstream and Downstram of the Turbu-Flow ™ Units

| | | | | | Iron Bacteria | | |
|---|---|---|---|---|---|---|---|
| | Dissolved Iron | | Ferrous iron | | (presence/absence) | | |
| | mg/L | | mg/L | | | | Cartridge |
| Location | Upstream | Downstream | Upstream | Downstream | Upstream | Downstream | Filter |
| Home 1 | <0.02 | <0.02 | <0.05 | <0.05 | Absence | Absence | Absence |
| Home 2 | <0.02 | <0.02 | <0.05 | <0.05 | Presence | Absence | Absence |
| Home 3 | <0.02 | <0.02 | <0.05 | <0.05 | Presence | Absence | — |
| Home 4 | <0.02 | <0.02 | <0.05 | <0.05 | Absence | Absence | — |
| Home 5 | <0.02 | <0.02 | <0.05 | <0.05 | Presence | Absence | Absence |
| Farm 1 | <0.02 | <0.02 | <0.05 | <0.05 | Absence | Absence | Absence |
| Farm 2 | <0.02 | <0.02 | 0.24 | 0.72 | Absence | Absence | Absence |
| MLH | | | | | Presence | Absence | — |

Table 7 presents the results of the total aerobic bacteria plate count on the water piping both upstream and downstream of the Turbu-Flow™ unit from samples collected on Dec. 6 and 7, 2005.

TABLE 7
Aerobic Colony Count from Samples Collected Upstream
and Downstream of the Turbu-Flow ™ Units

| | Aerobic Colony Count CFU/swab | | |
|---|---|---|---|
| Location | Upstream | Downstream | Cartridge Filter |
| Home 1 | <10 | <10 | 200 |
| Home 2 | <10 | 20 | <10 |
| Home 3 | <10 | 390 | — |
| Home 4 | 180 | <10 | — |
| Home 5 | <10 | <10 | <10 |
| Farm 1 | 1900 | 4100 | 2100 |
| Farm 2 | <10 | 2000 | — |
| MLH | 90 | <10 | — |

The results presented in Table 7 show that there is no consistent increase or decrease in the aerobic colony counts between the collected upstream and downstream swab samples.

Conclusions

The results of the sampling study showed that iron bacteria was found to be absent downstream of all of the Turbu-Flow™ unit where samples were collected. On average, there is no measurable difference between the upstream and downstream water samples for total suspended solids (TSS). There is no consistent increase or decrease of aerobic bacteria in the water pipes and cartridge filters downstream of the Turbu-Flow™ unit. Additional aerobic colony counts should measured at regular time intervals to identify if there is a sustained inhibition of biosolids growth and biofouling in the water pipes.

### EXAMPLE 7

### Continuous Spray Test with Untreated and Treated Water

A continuous spray test with treated and untreated water was performed in April 2005. A shower curtain was hung in a 4 foot diameter cooling tower barrel. On one side of the curtain, Turbu-Flow™ treated city water was continuously distributed via 6 spray nozzles, and on the other side of the curtain, untreated city water was continuously distributed via 6 spray nozzles. Swabs were taken weekly to count microorganism levels. At the end period, the samples from the treated side did not have enough microorganisms to measure. The untreated side was saturated with microorganisms. This test showed that city water treated by the Turbu-Flow™ system cannot grow microorganisms, while untreated water will encourage the growth of microorganisms.

While certain embodiments of the present invention have been described, it will be understood that various changes could be made in the above constructions without departing from the scope of the invention. It is intended that all matter contained in the above description or shown in the accompanying drawings shall be interpreted as illustrative and not in a limiting sense.

### EXAMPLE 8

### Measurement of Iron Ion Content in Water Treated by the NMR Pipetector™

Three units of the NMR Pipetector™ were installed on a water supply steel pipe and an air-conditioning steel pipe of a 15-year-old building. 500 ml of sample water was taken 1 to 3 days before the installation of the NMR Pipetector™, and 2 or 3 times on a regular basis between two weeks and four months after the installation of the NMR Pipetector™. Two methods of ICP Emission Spectral Analysis and Flameless Atomic Absorption Spectrometry were used as the measurement methods of the iron ion content in the water samples.

The results of the measured water samples are as follows: untreated water sample was measured to have an iron ion content of 0.789 mg/l; the iron ion content of the sample water has measurements of 0.48 mg/l in two weeks after the installation of the NMR Pipetector™ 0.49 mg/l after four weeks; and 0.27 mg/l after six weeks.

The results demonstrate that iron content of water treated by the NMR Pipetector™ decreased over time. And eventually, no iron ion was found in the pipe water that was treated by the NMR Pipetector™, which indicates that all of the iron oxide was converted to magnetite. The results also indicated that the reaction of reduction occurred and, at the same time, new form of corrosion was prevented.

### EXAMPLE 9

### Analysis of Magnetite Content in Water Present in Water Treated by the NMR Pipetector™

Installation of the Equipment

The NMR Pipetector™ was installed on an outlet pipe (inner diameter size is 200 mm) of hot-and-cold water generating machine, in which all of circulating hot-and-cold water passes through.

Method

Before the installation of the NMR Pipetector™, a sample (30 cm in length) of hot-and-cold water pipe (inner diameter size is 80 mm) was removed, and the removed pipe sample was replaced with new pipe material. Within one hour, at least 1 g of sample rust was isolated by a metal brush from about 100 cm² of rusted surface formed inside of the pipe. After the installation of the NMR Pipetector™, a sample (10 cm in length) of a pipe adjacent to the pipe from which the 30 cm sample was obtained.

Period of Sample Rust Measurement

The sample rust measurement was taken before installation of NMR Pipetector™, and after 3 months, 6 months, and 12 months after the installation of the equipment, for a total of 4 measurements.

Method of Measurement of the Weight Percentage of Magnetite (Fe₃O₄)

1. The rust sample was crushed and milled in a mortar, and the crushed sample was run through a sieve of a 100 μm mesh metal filter, which became fine powder of rust.

2. About 0.5 g of powder rust was isolated and placed in a 100 mL beaker, and the total weight of the beaker and rust was recorded.

3. 30 mL of purified water was added to the 100 ml beaker, and was mixed by a supersonic vibrator for 30 seconds.

4. Deposit of magnetite (Fe₃O₄) at the bottom of the beaker was collected by using a 3,000 gauss magnet which covered the bottom area of the beaker. The water and material in the 100 mL beaker except the magnetite held by the magnet, was transferred to a 200 mL beaker.

5. 30 mL of purified water was added to the 100 mL beaker and steps No. 3 and No. 4 from above was repeating three times.

6. Deposit of magnetite at the bottom of the 200 ml beaker was collected by using a 3,000 gauss magnet which covered the bottom area of the beaker. Left over liquid was discarded.

7. About 5 mL of purified water was added to the 200 mL beaker and mixed with the deposit of magnetite and the mixture was transferred to the 100 mL beaker.

8. 30 mL of purified water was added into the 100 mL beaker again and steps 3 through 7 were repeating five times.

9. About 5 mL of pure methyl alcohol was added to the 100 mL beaker and it was mixed with the magnetite by hand vibration. 10 minutes later, the methyl alcohol was discarded, and 5 mL of methyl alcohol was added again to the 100 mL beaker and step 9 was repeating one more time.

10. The methyl alcohol and deposit of magnetite at the bottom of the 100 mL beaker was dried for 30 minutes by a vacuum dryer at room temperature, and the dry weight of purified magnetite was measured by an electric fine weight checker.

Calculation

Weight percentage of magnetite (Fe₃O₄) was calculated by the following formula:
(Weight percentage of magnetite (Fe₃O₄)=(Purified magnetite (g)/Total weight of rust sample (g))×100%
Results

The results of the experiment are shown below in Table 8.

TABLE 8

| | Examination item |
|---|---|
| Term | Weight percentage of magnetite (Fe₃O₄) |
| Before installation | 2.2 |
| 3 months after installation | 14.4 |
| 6 months after installation | 53.4 |
| 12 months after installation | 72.9 |

The above results demonstrate that the weight percentage of magnetite present on the surface of rust that was in contact with water increased with time. This experiment confirmed that corrosion (FeO(OH)) was reduced to magnetite (Fe₃O₄) over time when the pipe water was treated by the NMR Pipetector™.

I claim:

1. A method for enhancing quality of a source liquid, comprising:
passing the source liquid through a low zeta potential crystal generator and thereby producing a treated liquid having an enhanced concentration of low zeta potential crystals; and
passing the treated liquid through a hydrated electron generator and thereby producing treated liquid having an enhanced concentration of low zeta potential crystals and hydrated electrons.

2. The method of claim 1, wherein the zeta potential of mineral crystals in the treated liquid after passage through the low zeta potential crystal generator is at least 25% less than the zeta potential of mineral particles in the source liquid.

3. The method of claim 1, wherein the zeta potential of mineral crystals in the treated liquid after passage through the low zeta potential crystal generator is at least 50% less than the zeta potential of mineral particles in the source liquid, and wherein the treated liquid is distributed for use in connection with systems selected from the group consisting of: liquid heating systems, liquid cooling systems, potable liquid systems, liquid systems in food processing applications, household liquid filtration systems, liquid systems in sanitation applications, liquid softeners, ion exchangers, and liquid systems in medical, dental, and industrial applications.

4. The method of claim 1, wherein the zeta potential of mineral crystals in the treated liquid after passage through the low zeta potential crystal generator is between about −5 mV and −9 mV, and wherein the treated liquid is distributed for use in connection with systems selected from the group consisting of: liquid heating systems, liquid cooling systems, potable liquid systems, liquid systems in food processing applications, household liquid filtration systems, liquid systems in sanitation applications, liquid softeners, ion exchangers, and liquid systems in medical, dental, and industrial applications.

5. The method of claim 1, further comprising passing the treated liquid through at least one filtration device to reduce concentration of microorganisms in the treated liquid, thereby producing treated liquid having an enhanced concentration of low zeta potential crystals and hydrated electrons, and reduced microbial populations.

6. The method of claim 1, further comprising passing the treated liquid through a pre-filtration system for substantially removing minerals from the treated liquid source prior to treatment in the at least one filtration device, wherein the minerals are selected from the group consisting of: iron, sulphur, manganese, and combinations thereof.

7. The method of claim 1, further comprising passing the source liquid through a pre-treatment system for substantially removing contaminants from the source liquid prior to treatment in the low zeta potential crystal generator and the hydrated electron generator, wherein the contaminants are selected from the group consisting of: debris, oils, and substances that would interfere with crystallization treatment.

8. The method of claim 1, further comprising passing the source liquid through a pre-treatment system for introducing additives to the source liquid prior to treatment in the low zeta potential crystal generator and the hydrated electron generator, wherein the additives are selected from the group consisting of: Calcium, Titanium, Vanadium, Chromium, Manganese, Iron, Cobalt, Nickel, Copper, Zinc, Molybdenum, Silver, Cadmium, Gold, Platinum, and combinations thereof.

9. The method of claim 1, further comprising passing the treated liquid through a high zeta potential crystal generator and thereby producing treated liquid having an enhanced concentration of high zeta potential crystals and hydrated electrons.

10. The method of claim 1, further comprising passing the treated liquid through a second low zeta potential crystal generator, thereby producing treated liquid having an enhanced concentration of low zeta potential crystals and hydrated electrons.

11. The method of claim 1, further comprising passing the treated liquid through a second hydrated electron generator, thereby producing treated liquid having an enhanced concentration of low zeta potential crystals and hydrated electrons.

12. A system for enhancing quality of a source liquid, comprising:
a source input;
a low zeta potential crystal generator in liquid communication with the source liquid input;
a hydrated electron generator in liquid communication with the source liquid input or the low zeta potential crystal generator;
a treated liquid output in liquid communication with the low zeta potential crystal generator or the hydrated electron generator,
wherein the treated liquid has an enhanced concentration of low zeta potential crystals and hydrated electrons compared to the source liquid.

13. The system of claim 12, wherein the low zeta potential crystal generator is capable of reducing the zeta potential of mineral particles in source liquid by at least 25%.

14. The system of claim 12, wherein the low zeta potential crystal generator is capable of reducing the zeta potential of mineral particles in source liquid by at least 50%, and whereby the treated liquid is distributed for use in connection with systems selected from the group consisting of: liquid heating systems, liquid cooling systems, potable liquid systems, liquid systems in food processing applications, household liquid filtration systems, liquid systems in sanitation applications, liquid softeners, ion exchangers, and liquid systems in medical, dental, and industrial applications.

15. The system of claim 12, wherein the low zeta potential crystal generator is capable of producing treated water having a zeta potential of between about −5 mV and −9 mV, and whereby the treated liquid is distributed for use in connection with systems selected from the group consisting of: liquid heating systems, liquid cooling systems, potable liquid systems, liquid systems in food processing applications, household liquid filtration systems, liquid systems in sanitation applications, liquid softeners, ion exchangers, and liquid systems in medical, dental, and industrial applications.

16. The system of claim 12, further comprising at least one filtration device in liquid communication with the treated liquid output and the low zeta potential crystal generator or the hydrated electron generator.

17. The system of claim 16, further comprising a pre-filtration system in liquid communication with the at least one filtration device and the low zeta potential crystal generator or the hydrated electron generator.

18. The system of claim 12, further comprising a pre-treatment system in liquid communication with the source liquid input and the low zeta potential crystal generator or the hydrated electron generator.

19. The system of claim 12, further comprising a second low zeta potential crystal generator in liquid communication with the hydrated electron generator and the treated liquid output.

20. The system of claim 12, further comprising a second hydrated electron generator in liquid communication with the low zeta potential crystal generator and the treated liquid output.
